(19) United States
(12) Patent Application Publication
(10) Pub. No.: US 2019/0103065 A1
(43) Pub. Date: Apr. 4, 2019

(54) DISPLAY SCREEN

(71) Applicant: Lenovo (Beijing) Co., Ltd., Beijing (CN)

(72) Inventors: Youze LI, Beijing (CN); Jun SHI, Beijing (CN)

(21) Appl. No.: 15/941,720

(22) Filed: Mar. 30, 2018

(30) Foreign Application Priority Data
Sep. 30, 2017 (CN) 201710916447.7

(51) Int. Cl. G09G 3/36

(52) U.S. Cl. CPC G09G 3/3648; G09G 2300/0452; G09G 2330/021; G09G 2320/0633

(57) ABSTRACT

A display screen is provided. The display screen comprises a plurality of pixel units. Each pixel unit includes a plurality of subpixels and the subpixels includes at least a red subpixel, a green subpixel, and a blue subpixel, wherein one or more first subpixels of the subpixels have a resistor used to adjust a brightness level for the one or more first subpixels.

### CROSS-REFERENCES TO RELATED APPLICATIONS

This application claims priority of Chinese Patent Application No. 201710916447.7, filed on Sep. 30, 2017, the entire contents of which are hereby incorporated by reference.

### FIELD OF THE INVENTION

The present disclosure generally relates to the field of display screen technology and, more particularly, relates to a liquid-crystal display screen.

### BACKGROUND

Liquid-crystal display (LCD) screens have been widely applied in a variety of electronic devices and usually are designed to be of a rectangular shape. Nevertheless, with the advent of more and more electronic products having non-rectangular display panels, e.g., smart watch, mobile phone, etc., the LCD screens are correspondingly designed to be rounded or have rounded corners. The smallest element comprising the LCD screens is a pixel of a size from tens to hundreds of micrometers. The pixels at the edges of the non-rectangular LCD screens are arranged in a non-linear manner, e.g., in a curve or a rounded corner. As a result, a serrated pattern can be readily observed at the edges of the screens even with the naked eye, which significantly deteriorates user experience.

There are known solutions proposed to overcome the above problem. For example, an optimized algorithm aiming at the serrated pattern can be integrated into LCD driving integrated circuits (ICs). Nonetheless, this solution can bring more power consumption to the driving IC, and varying capabilities of the optimized algorithms in different driving ICs can lead to an inconsistent display effect. Or other optimized algorithms aiming at the serrated pattern can be added into LCD driving platforms. However, this method needs to apply a layer of blurring mask aiming at the serrated pattern on all displayed images, thus correspondingly an additional application needs to be added into the system and kept always running, which can also increase the system's power consumption and result in a poor compatibility due to the fact that the developers have to design a variety of blurring masks aiming at various applications of different platforms. In the meantime, varying optimization capabilities in different platforms also bring about the inconsistent display effect.

The disclosed display screen is directed to solve one or more problems set forth above and other problems.

### BRIEF SUMMARY OF THE DISCLOSURE

One aspect of the present disclosure provides a display screen. The display screen comprises a plurality of pixel units. Each pixel unit includes a plurality of subpixels and the subpixels includes at least a red subpixel, a green subpixel, and a blue subpixel, wherein one or more first subpixels of the subpixels have a resistor used to adjust a brightness level for the one or more first subpixels.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates an equivalent circuit diagram of a display screen;

FIG. 2 illustrates an equivalent circuit diagram of a display screen consistent with disclosed embodiments;

FIG. 3 illustrates an equivalent circuit diagram of another display screen consistent with disclosed embodiments;

FIG. 4A illustrates a schematic diagram of a common serrated pattern appearing on a curved edge of an existing display screen; and

FIG. 4B illustrates a schematic diagram of a display effect of a display screen consistent with disclosed embodiments.

### DETAILED DESCRIPTION

To make the purposes, the technical schemes and the advantages of the present disclosure more obvious, the following embodiments of the present disclosure will be described in detail with reference to the accompanying drawings. It is clear that the described embodiments are only part of the embodiments of the present disclosure, and not all embodiments of the present disclosure. Based on the embodiments described in the present disclosure, other embodiments obtained by the technical personnel skilled in the art without creative labor shall fall into the scope of protection of the present disclosure.

Further, in this specification and the appended drawings, elements that are basically the same have been denoted with the same reference numerals, and repetitive explanation of these elements may be omitted. Moreover, detailed descriptions of functions and configurations well known in the art may be omitted in order to make the description clearer and more concise.

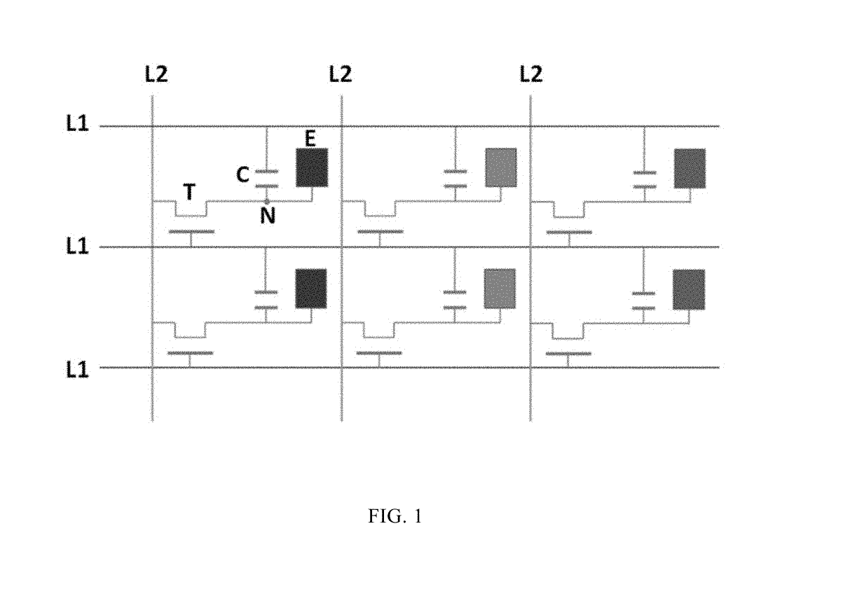

FIG. 1 illustrates an equivalent circuit diagram of a display screen. The display principle of the display screen in the present disclosure will be described with reference to FIG. 1. In the following description, the liquid crystal display (LCD) screen will be used as an example of the display screen in the present disclosure, and it can be understood that the type of the display screen is not limited to the LCD screen.

As shown in FIG. 1, a plurality of horizontal scanning lines L1 and vertical scanning lines L2 intersect with each other in the display screen. Here, a subpixel is an area confined by the intersected scanning lines. After the light emitted from a backlight source passes through each subpixel, a corresponding display effect can be outputted. As described in detail below, in different color spaces, a composite image is entirely displayed on the screen by superposing all of the display outputs from these adjacent subpixels with different proportions.

Further, the structure of the subpixel will be described. As shown in FIG. 1, each subpixel includes a transistor T, a pixel electrode E, and a pixel capacitor C. Hereafter, a thin-film transistor will be illustrated as an example of the transistor T. The horizontal scanning line, L1, is also called gate scanning line and used to connect with the gate electrode of the thin-film transistor for each subpixel. The vertical scanning line, L2, is also called source scanning line and used to connect with the source electrode of the thin-film transistor for each pixel. The gate scanning line can switch on and/off the thin-film transistor, while the source scanning line can supply power to the thin-film transistor.

Further as shown in FIG. 1, for each pixel, the source electrode of the thin-film transistor T is coupled to the source scanning line corresponding to the subpixel, the gate electrode of the thin-film transistor T is coupled to the gate scanning line corresponding to the subpixel, and the drain electrode of the thin-film transistor T is coupled to the pixel electrode E corresponding to the subpixel. The pixel capacitor C is coupled between a first node and the gate scanning line corresponding to the subpixels in the last row. The first node is a point on the line connecting the drain electrode of the thin-film transistor T and the pixel electrode E. That is, the pixel capacitor C of the thin-film transistor T is coupled across the pixel electrode E. It should be understood that the type of the transistor T described in the present disclosure is not limited to the thin-film transistor in the present embodiments.

With the above configuration, gate control signals are sequentially inputted to each gate scanning line in an ordered manner, e.g., from top to bottom. After a gate control signal is inputted to a gate scanning line in a row, all thin-film transistors coupled with the gate scanning line in the row are switched on. If a data signal is subsequently inputted to a source scanning line connected with a thin-film transistor in the row, a voltage of the data signal on the source scanning line will be applied to the pixel electrode connected with the drain electrode of the thin-film transistor, and the pixel capacitor connected with the thin-film transistor will be charged. The brightness level of the pixel electrode depends on the voltage charged at the pixel capacitor. Due to the wave-particle duality of light, light waves are vectorial in the process of propagation. Hence, after the light emitted from the backlight source passes through the pixel electrode coupled with a liquid-crystal layer, by exploiting liquid-crystal molecules that have anisotropic optoelectronic properties and applying a voltage (i.e., an electric field) to the liquid-crystal molecules, the rotation of the liquid-crystal molecules can be controlled to change the orientation of the polarization of the incident light as it passes through the liquid-crystal layer. As such, the amount of the light passing through the liquid-crystal layer of the pixel electrode can be adjusted by controlling the rotation of the liquid-crystal molecules. The less the amount of the light passes through, the lower the brightness level, and vice versa. Therefore, the brightness level of the corresponding subpixel can be determined by the voltage of the pixel capacitor coupling across the pixel electrode of the subpixel.

As described above, after the pixel capacitor of the subpixel corresponding to the gate scanning line in the last row is charged, the gate control signal is subsequently inputted to the gate scanning line in the next row. In the meantime, the gate control signal is stopped from inputting to the gate scanning line in the last row, such that all the thin-film transistors connected with the gate scanning line in the last row are switched off. At this point, if the data signal is reapplied to a source scanning line connected with a thin-film transistor that is switched on in the current row as described above, the pixel capacitor connected with the thin-film transistor of the subpixel corresponding to the gate scanning line in the current row will be charged. After the above process is repeated until the pixel capacitor of the subpixel in each row is charged, the above process is restarted from the gate scanning line in the first row, such that a corresponding display output can be displayed on the screen.

Further, the corresponding display output on the screen comprises the superposition of the display output from each subpixel. As described above, a different display effect can be outputted after the light passes through each subpixel. For example, in the RGB color space, a plurality of subpixels can include a red subpixel, a green subpixel, and a blue subpixel. The pixel unit in each row can be sequentially arranged in order of red subpixel, green subpixel, and blue subpixel. Accordingly, any color displayed on the screen can be obtained by mixing the red, green, blue lights output from the three adjacent subpixels in different proportions. Hence, a pixel unit can include three adjacent red, green, and blue subpixels for display, that is, the screen can comprise a plurality of such pixel units. It should be understood that the type of the color space is not limited thereto. For example, the color space can be of other types, such as YUV, an HSV, etc. Regarding the different color spaces, the corresponding pixel units can include other types of subpixels and the subpixels can be configured in a corresponding manner.

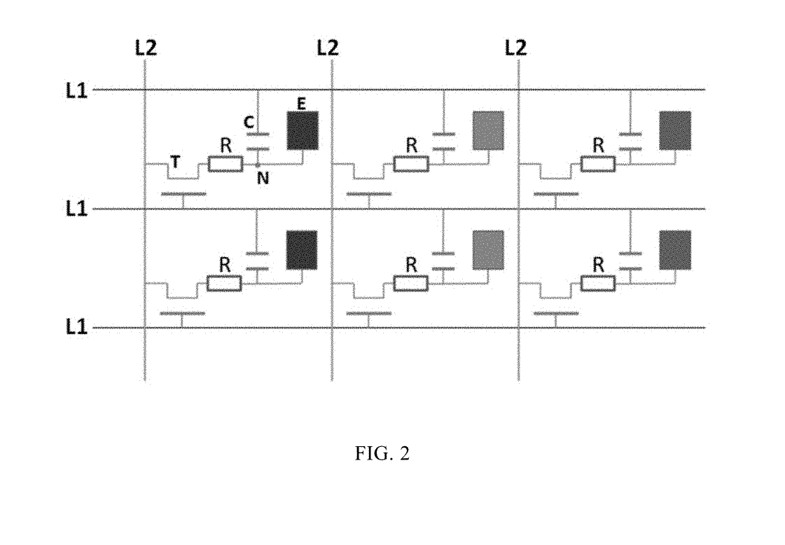

Further, the display principle of a display screen consistent with the present disclosure will be illustrated with reference to FIG. 2. FIG. 2 illustrates an equivalent circuit diagram of a display screen consistent with disclosed embodiments.

As shown in FIG. 2, the difference between the circuit structure of the display screen consistent with the present disclosure and the circuit structure shown in FIG. 1 includes at least that the subpixel of the display screen consistent with the present disclosure further includes a resistor R, which may be used for adjusting the brightness level of a first subpixel. Other aspects of the two circuit structures that are similar are not repeated herein.

In one embodiment of the present disclosure, the brightness level of the subpixel of the display screen may be determined by the voltage charged at the pixel capacitor, which couples across the pixel electrode of the subpixel. In a predetermined range, the higher the voltage is, the higher the brightness level of the subpixel may reach, and vice versa. It should be understood that there may be another type of display screen, for which the higher the voltage charged at the pixel capacitor is, the lower the brightness level of the subpixel may become. And with respect to different display screens, the voltage corresponding to the maximum brightness level of the subpixel that can be charged at the pixel capacitor may also be different. For example, after the voltage is charged to 5V-5.5V at the pixel capacitor, the brightness of the corresponding subpixel may reach the highest level. Because the brightness level of the subpixel can be adjusted by changing the rotation of the liquid-crystal molecules via applying the voltage (i.e., the electric field) to alter the orientation of the polarization of the light passing through the liquid-crystal layer, the brightness level of the subpixel may be controlled by coupling a resistor of an appropriate resistance with the subpixel to adjust the voltage that can be charged at the pixel capacitor.

As shown in FIG. 2, in one embodiment of the present disclosure, a resistor R is placed between a first node N and a drain electrode of the thin-film transistor T in a subpixel. After the gate control signal is inputted to the gate scanning line corresponding to the subpixel, the voltage of the data signal input to the corresponding source scanning line may be applied to the resistor R and the pixel electrode E of the subpixel. Since the resistor R is connected in series with the pixel electrode E, the greater the resistance of the resistor R is, the less voltage may be divided across the pixel electrode E that is connected in series with the resistor R. Hence, the voltage charged at the pixel capacitor of the subpixel can be determined by the resistance of the resistor R configured to the subpixel, such that the brightness level of the subpixel can be adjusted by varying the resistance of the resistor R.

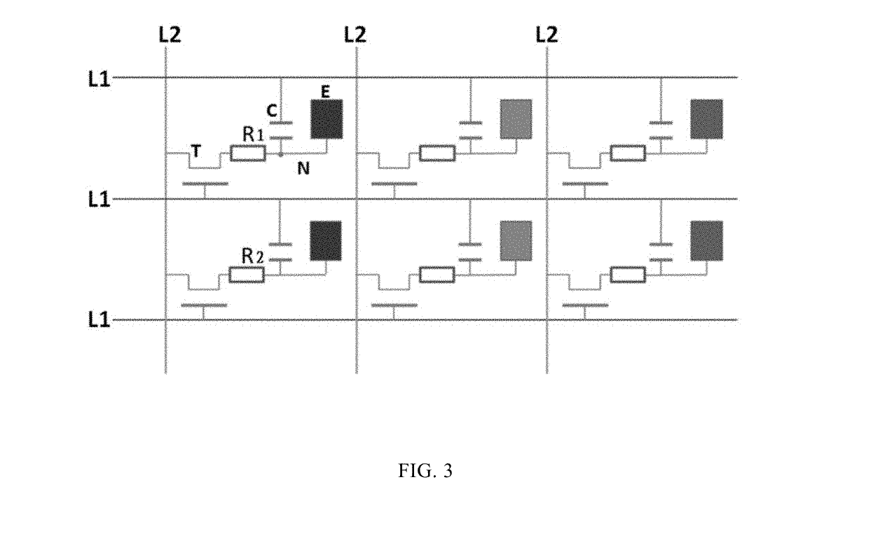

FIG. 3 illustrates an equivalent circuit diagram of another display screen consistent with disclosed embodiments. The resistor R for adjusting the brightness level of the first subpixel may be coupled to one or more subpixels. And a plurality of resistors with different resistance values may be coupled to different subpixels, thus allowing different subpixels to have different brightness levels. For example, as shown in FIG. 3, a resistor R1 having a first resistance value is coupled to a first subpixel in the first row, a resistor R2 having a second resistance value is coupled to a second subpixel in the second row, and the first resistance value is different from the second resistance value. Hence, the brightness levels of the first subpixel and the second subpixel are also different.

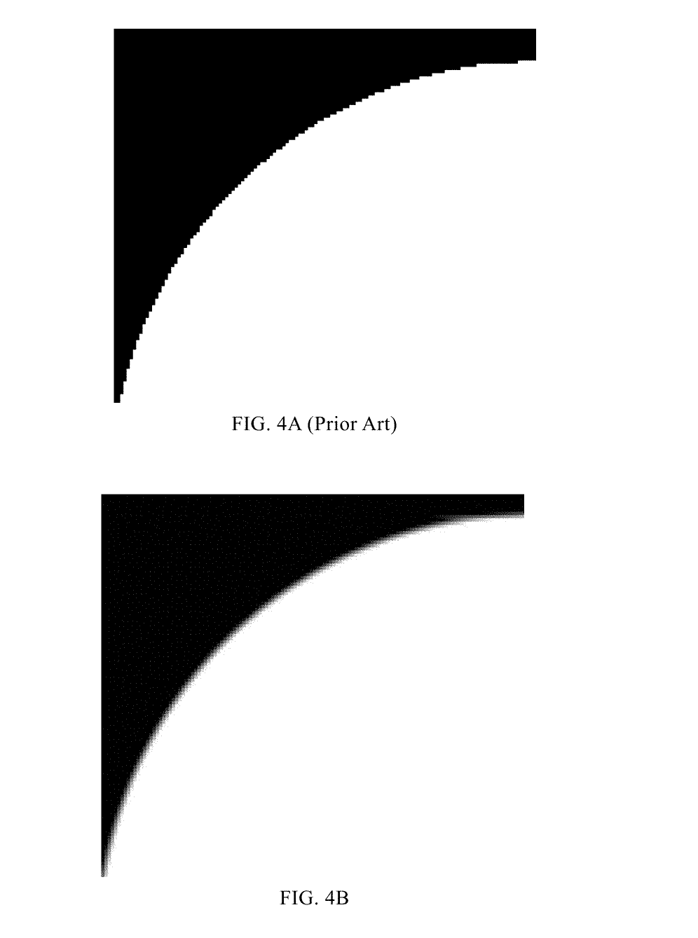

The display screen may be of a non-rectangular shape and hence the pixels on the edge of the display screen may not be arranged in a straight line. For example, if the display screen has a round shape, the pixels on the rounded edge are arranged in a curve. The technical effects of the present disclosure are illustrated by reference to FIG. 4A and FIG. 4B. FIG. 4A illustrates a schematic diagram of a common serrated pattern appearing on a curved edge of an existing display screen, and FIG. 4B illustrates a schematic diagram of a display effect of a disclosed display screen consistent with disclosed embodiments.

As shown in FIG. 4A, without the treatment of the brightness level on the subpixels of the display screen, the brightness of each pixel of the display screen is approximately or completely the same. Due to the non-linear arrangement for the square- or rectangle-shaped subpixels on the curved edge of the round-shaped display screen, a serrated pattern apparently arises under the condition that the subpixels around the curved edge have the same brightness level, leading to a poor display effect. For the purposes of blurring the serrated pattern and making the display transition smoother, the subpixels around the curved edge of the display screen need to be treated.

In one embodiment of the present disclosure, the resistor R, used for adjusting the brightness level of the subpixels, may be coupled to the plurality of the subpixels around the curved edge of the round-shaped display screen. By setting an appropriate resistance value for the resistor R, the brightness level of the subpixels around the curved edge may be reduced, resulting in a blurring effect on the serrated pattern. Or otherwise, in another embodiment of the present disclosure, a plurality of resistors with different resistance values may be coupled to the plurality of subpixels around the curved edge of the round-shaped display screen for setting different brightness levels. As described above, the first and the second subpixels around the curved edge of the round-shaped display screen may include resistors R1 and R2 for setting the brightness levels of the first and the second subpixels, respectively. The first subpixel may lie closer to the outside perimeter of the display output area than the second subpixel and the resistance value of the resistor R1 may be greater than that of the resistor R2, such that the brightness of the subpixels around the curved edge of the display screen can gradually decrease from the inside to the outside. As shown in FIG. 4B, there is a gradual transition in gray level intensity around the curved edge of the display screen consistent with the present disclosure, thereby further blurring the serrated pattern.

It can be seen that the display screen consistent with the present disclosure can optimize the display effect by improving the circuit structure of the subpixels, that is, the display effect can be improved through enhancements in hardware. Compared with the enhancements in software (e.g., the anti-aliasing algorithm) to improve the display effect, the display screen consistent with the present disclosure does not require a developer to design various algorithms for different application interfaces or display areas and hence can have a better compatibility. Moreover, no additional software is needed to optimize the display effect, the display screen consistent with the present disclosure can consume less power and eliminate the inconsistency in display effect caused by different optimization capabilities of software on different platforms.

It should be understood that the present disclosure is not limited to the above embodiments. The display screen may be of a square shape with rounded corners, non-rectangular shapes such as an elliptical shape, etc., or a rectangular shape. If the display screen is of other shapes, the subpixels located at the corresponding positions can also be configured in the above manners to adjust the brightness levels of the subpixels for blurring the serrated pattern. Likewise, it can be understood that the present disclosure is not limited to blur the serrated pattern on the edge of the display screen. For example, the brightness levels of the subpixels located in a specific area or arranged in a specific layout can be configured in the above manners to achieve different display effects, such as highlighting, blurring, gradual transition, etc. That is, other embodiments that improve the display effect of the display screen by adjusting the brightness levels of the subpixels can all be regarded as equivalent variations of the embodiments consistent with the present disclosure.

What is claimed is:

1. A display screen, comprising:
a plurality of pixel units, each pixel unit including a plurality of subpixels and the subpixels including at least a red subpixel, a green subpixel, and a blue subpixel,
wherein one or more first subpixels of the subpixels have a resistor used to adjust a brightness level for the one or more first subpixels.

2. The display screen according to claim 1, wherein:
the subpixels include at least one or more second subpixels, and the second subpixels have a resistor used to adjust the brightness level for the second subpixels; and
a resistance of the resistor of the second subpixels is different from a resistance of the resistor of the first subpixels such that the brightness level of the first subpixels is different from the brightness level of the second subpixels.

3. The display screen according to claim 2, wherein:
the subpixels are arranged in a first layout, in which the first subpixels and the second subpixels are placed in a predetermined area; and
position of the first subpixels and position of the second subpixels in the predetermined area are different, such that any image displayed around the predetermined area can have a gradual transition effect.

4. The display screen according to claim 3, wherein:
the predetermined area is peripheral areas of a display output field of the display screen; and
the first subpixels are closer to an outside perimeter of the display output field of the display screen than the second subpixels.

5. The display screen according to claim 3, wherein the subpixels are arranged in a non-straight line according to the first layout.

6. The display screen according to claim 3, wherein the brightness level of the first subpixels is lower than the brightness level of the second subpixels.

7. The display screen according to claim 1, comprising:
a plurality of first scanning lines; and
a plurality of second scanning lines,
wherein:
the plurality of first scanning lines and the plurality of second scanning lines intersect with each other to form the plurality of subpixels;
the first subpixels and the second subpixels each include a transistor, a pixel electrode, and a pixel capacitor;
a first terminal of the transistor of a subpixel is coupled to the first scanning line corresponding to the subpixel;
a second terminal of the transistor of the subpixel is coupled to the second scanning line corresponding to the subpixel;
the pixel capacitor of the subpixel is coupled between a first node and the first scanning line in a last row;
the pixel electrode of the subpixel is coupled to the first node; and
the resistor for adjusting the brightness level of the first subpixels is coupled between a third terminal of the transistor and the first node of a first subpixel.

8. The display screen according to claim 7, wherein:
the first scanning line is used to switch on and/or off the transistor;
the second scanning line is used to supply power to the transistor; and
after the transistor is switched on, the transistor charges the pixel capacitor for enabling the subpixel to display different brightness levels according to a voltage charged at the pixel capacitor.

9. The display screen according to claim 8, wherein:
after the pixel capacitors of the first subpixels and the second subpixels are charged, the voltage value reached in charging the pixel capacitor is adjusted by changing the resistance of the resistor that is used to adjust the brightness level for the first subpixels.

10. The display screen according to claim 1, wherein the transistor is a thin-film transistor.
